(19) United States
(12) Patent Application Publication
(10) Pub. No.: US 2005/0097442 A1
(43) Pub. Date: May 5, 2005

(54) Data processing system and method

(75) Inventor: Stuart A. Green, Sheffield (GB)

Correspondence Address: WILMER CUTLER PICKERING HALE AND DORR LLP, 60 STATE STREET, BOSTON, MA, 02109, US

(73) Assignee: Zoo Digital Group Plc

(21) Appl. No.: 10/757,672

(22) Filed: Jan. 14, 2004

(30) Foreign Application Priority Data
Nov. 4, 2003 (GB) GB 0325708.6

(51) Int. Cl. G06F 15/00

(52) U.S. Cl. 715/501.1

(57) ABSTRACT

An authoring method for creating an audiovisual product. The method has three main stages. The first stage defines components implicitly representing functional sections of audiovisual content and transitions that represent movements between components. The second stage expands the components and transitions to provide a set of explicitly realised AV assets and an expanded intermediate data structure of nodes and links. Each node is associated with one of the AV assets and the links represent movement from one node to another. The third stage creates the audiovisual product in a predetermined output format, using the AV assets and the expanded intermediate data structure of the nodes and the links, wherein the audiovisual product comprises data to produce, or at least emulate, scrolling image data.

### FIELD OF THE INVENTION

The present invention relates in general to a data processing method and system.

### BACKGROUND TO THE INVENTION

In general terms, it is desired to assemble many small sections of raw audio and video content (i.e. sound clips and video clips) to form a finished audiovisual product, by way of an authoring process. However, in many environments a considerable degree of specialist knowledge and time must be invested in the authoring process in order to achieve a desirable finished audiovisual product. These problems are exacerbated where the audiovisual product has a complex navigational structure or requires many separate raw content objects.

As a simple example, a feature movie or television program typically has a straightforward linear navigational sequence of individual scenes. By contrast, it is now desired to develop new categories of audiovisual products which have a much more complex navigational structure, such as a movie with many scene choices or different movie endings, and/or which have a large number of individual scenes, such as an interactive quiz game with say one thousand individual quiz questions.

An optical disc is a convenient storage media for many different purposes. A digital versatile disc (DVD) has been developed with a capacity of up to 4.7 Gb on a single-sided single-layer disc, and up to 17 Gb on a double-sided double-layer disc. There are presently several different formats for recording data onto a DVD disc, including DVD-video, DVD-audio, and DVD RAM, amongst others. Of these, DVD-video is particularly intended for use with pre-recorded video content, such as a motion picture. As a result of the large storage capacity and ease of use, DVD discs are becoming popular and commercially important. Conveniently, a DVD-video disc is played using a dedicated playback device with relatively simple user controls, and DVD players for playing DVD-video discs are becoming relatively widespread. More detailed background information concerning the DVD-video specification is available from DVD Forum at www.dvdforum.org.

Although DVD-video discs and DVD-video players are becoming popular and widespread, at present only a limited range of content has been developed. In particular, a problem arises in that, although the DVD specification is very flexible, it is also very complex. The process of authoring content into a DVD-video compatible format is relatively expensive and time consuming. In practice, the flexibility and functions allowed in the DVD-video specification are compromised by the expensive and time consuming authoring task. Consequently, current DVD-video discs are relatively simple in their navigational complexity. Such simplicity can impede a user's enjoyment of a DVD-video disc, and also inhibits the development of new categories of DVD-video products.

An example DVD authoring tool is disclosed in WO 99/38098 (Spruce Technologies) which provides an interactive graphical authoring interface and data management engine. This known authoring tool requires a relatively knowledgeable and experienced operator and encounters difficulties when attempting to develop an audiovisual product having a complex navigational structure. In particular, despite providing a graphical user interface, the navigational structure of the desired DVD-video product must be explicitly defined by the author. Hence, creating a DVD-video product with a complex navigational structure is expensive, time-consuming and error-prone.

DVDs represent one of the fastest growing forms of multimedia entertainment throughout the world. Conventionally, DVDs have been used to present movies to users using extremely high quality digital audio/visual content. FIG. 14 shows, schematically, a typical home entertainment system 1400 comprising a DVD player 1402, a DVD 1404 and a television 1406. The DVD 1404 contains a number of programs or cells 1408 each of which comprises corresponding digital audio-visual content 1410 together with respective navigation data 1412. The navigation data 1412 is used by a navigation engine 1414 within the DVD player 1402 to control the order or manner of presentation of the digital content 1410 by a presentation engine 1416. The presentation engine 1416 presents the digital content 1410 on the television 1406 as rendered audio-visual content 1418. As is well known within the art, the rendered audio-visual content 1418 conventionally, takes the form a movie or photographic stills or text associated with that movie; so-called Bonus features.

A user (not shown) can use a remote control 1420 associated with the DVD player 1402 to influence the operation of the navigation engine 1414 via an infrared remote control interface 1422. The combination of the infrared remote control 1420 and the navigation engine 1414 allows the user to make various selections from any menus presented by the presentation engine 116 under the control of the navigation engine 1414 as mentioned above.

FIG. 15 shows, schematically, a pair 1500 of text screen stills that may represent text that can be stepped through by the user using their remote control 1420. Typically, the screens stills would be merely two such stills or a number of stills. It can be appreciated that the first screen still 1502 comprises a number of lines of text 1504 together with forwards 1506 and backwards 1508 menu or arrow options. The forwards 1506 and backwards 1508 arrow or menu options allow the user, using their infrared remote control 1420, to move to the previous text screen still or to the next text screen still. In the illustrated example, a second screen still 1504 is displayed in response to the user selecting the forwards arrow 1506 menu option. It can be appreciated that the second screen still also contains a body of text 1510 and forwards 1512 and backwards 1514 arrow menu options.

Due to the relatively limited set of commands that might form the navigation data, the processing performed by the DVD player and, in particular, the navigation engine 1414, is relatively simple and largely limited to responding to infrared remote control commands and retrieving and displaying, via the presentation engine 1416, pre-authored or pre-determined digital audio-visual content 1410. Beyond decoding and presenting the digital audio-visual content 1410 as rendered A/V content 1418, the DVD player 1402 performs relatively little real-time processing.

This can be contrasted with the relatively sophisticated real-time processing performed by computers when presenting, for example, text documents such as those produced using Word available from Microsoft Corporation. FIG. 16 depicts, schematically, a display process 1600 for displaying part 1602 of a Word document 1608 on a screen 1604 of a computer system (not shown). The screen 1604 conventionally also contains a scroll bar 1606 that can be used to display other parts of the global Word document 1608. The part 1602 of the Word document currently displayed is determined by a “window” 1610 that is capable of traversing the global word document 1608 to display various portions of that document 1608 which are currently of interest to a user. The processing necessary for such scrolling through the text 1612 of the document 1608 is performed in real-time. Effectively, the microprocessor of the computer together with its instruction set is sufficiently sophisticated and flexible to imbue the Word application (not shown) with the capability to perform the necessary calculations and manipulations to implement scrolling through the Word document 1608. It will be appreciated that each time the user scrolls to a different section of the global Word document 1608, the part of the word document 1602 shown on the screen 1604 is updated, in real-time, in response to any scroll commands issued by the user.

It will be appreciated that this is in stark contrast to the display of text information via the DVD player 1402 and the relatively crude or unsophisticated manner of stepping through that information as shown in FIG. 15. Current DVD players are unable to perform the real-time processing necessary to realise scrolling of data or images in a manner that is similar to that performed by computers primarily due to the very limited instruction set that forms the navigation data and that controls the presentation engine.

It is an object of embodiments of the present invention at least to mitigate some of the problems of the prior art.

### SUMMARY OF INVENTION

In a first aspect of the present invention there is provided an authoring method for use in creating an audiovisual product, comprising the steps of: defining a plurality of components, the components implicitly representing functional sections of audiovisual content with respect to one or more raw content objects, and a plurality of transitions that represent movements between the plurality of components; expanding the plurality of components and the plurality of transitions to provide a set of explicitly realised AV assets and an expanded intermediate data structure of nodes and links, where each node is associated with an AV asset of the set and the links represent movement from one node to another; and creating an audiovisual product in a predetermined output format, using the AV assets and the expanded intermediate data structure of the nodes and the links, wherein the audiovisual product comprises data representing at least a set of data for producing, or at least emulating, scrolling image data.

In one preferred embodiment, the present invention relates to authoring of audiovisual content into a form compliant with a specification for DVD-video and able to be recorded on an optical disc recording medium.

In a second aspect of the present invention there is provided an authoring method for use in creating a DVD-video product, comprising the steps of: creating a plurality of components representing parameterised sections of audiovisual content, and a plurality of transitions representing movements between components; expanding the plurality of components and the plurality of transitions to provide a set of AV assets and an expanded data structure of nodes and links, where each node is associated with an AV asset of the set and the links represent movement from one node to another; and creating a DVD-video format data structure from the AV assets, using the nodes and links, wherein the DVD-video format data comprises data representing, or at least emulating, scrolling image data.

In a third aspect of the present invention there is provided an authoring method for use in creating an audiovisual product according to a DVD-video specification, comprising the steps of: generating a set of AV assets each comprising a video object, zero or more audio objects and zero or more sub-picture objects, and an expanded data structure of nodes and links, where each node is associated with one AV asset of the set and the links represent navigational movement from one node to another; and creating a DVD-video format data structure from the set of AV assets, using the nodes and links; the method characterised by the steps of: creating a plurality of components and a plurality of transitions, where a component implicitly defines a plurality of AV assets by referring to a presentation template and to items of raw content substitutable in the presentation template, and the plurality of transitions represent navigational movements between components; and expanding the plurality of components and the plurality of transitions to generate the set of AV assets and the expanded data structure of nodes and links, wherein the set of AV assets and the expanded data structure comprise scrolling image data.

In another aspect the present invention there is provided a recording medium having recorded thereon computer implementable instructions for performing any of the methods defined herein.

In yet another aspect of the present invention there is provided a recording medium having recorded thereon an audiovisual product authored according to any of the methods defined herein.

Advantageously, embodiments can provide a convenient and simple method and apparatus for authoring an audio-visual product.

Preferred embodiments provide a method and apparatus able to create an audio-visual product having a complex navigational structure and/or having many individual content objects, whilst reducing a time required for authoring and minimising a need for highly skilled operators.

Preferably, there is provided an authoring tool that is intuitive to use and is highly flexible.

Particularly preferred embodiments support creation of audio-visual products such as DVD-video products that run on commonly available DVD-video players.

Accordingly, a first aspect of embodiments of the present invention provides a data processing method for authoring optical medium data; the method comprising the step of:

producing, from data representing a static visual asset, a set of visual assets in which each visual asset of the set comprises data unique to that asset and data common to that asset and at least one other visual asset of the set; each visual asset of the set having respective defined dimensions.

Advantageously, embodiments of the present invention allow scrolling of image data by a DVD player to be realised, that is, the embodiments allow the real-time scrolling performed by computers to be emulated at least.

### BRIEF DESCRIPTION OF THE DRAWINGS

Embodiments of the present invention will now be described, by way of example only, with reference to the accompanying drawings in which:

FIG. 1 is an overview of an authoring method according to a preferred embodiment;

FIG. 2 is a schematic diagram showing a simple abstraction of a desired audiovisual product;

FIG. 3 shows in more detail a component used as part of the abstraction of FIG. 2;

FIG. 4 illustrates an example prior art authoring method compared with an example preferred embodiment;

FIG. 5 depicts another example embodiment of the present authoring method using components and transitions;

FIG. 6 shows the example of FIG. 5 in a tabular format;

FIG. 7 is an overview of a method for evaluating components and transitions;

FIG. 8 depicts evaluation of components in more detail;

FIG. 9 shows evaluation of transitions in more detail;

FIG. 10 illustrates a portion of an expanded data structure during evaluation of components and transitions;

FIG. 11 is an overview of a preferred method for creating DVD-video structures from an expanded data structure;

FIG. 12 shows a step of creating DVD video structure locations in more detail;

FIG. 13 depicts a step of creating DVD-video compatible data structures in more detail;

FIG. 14 shows a home entertainment system;

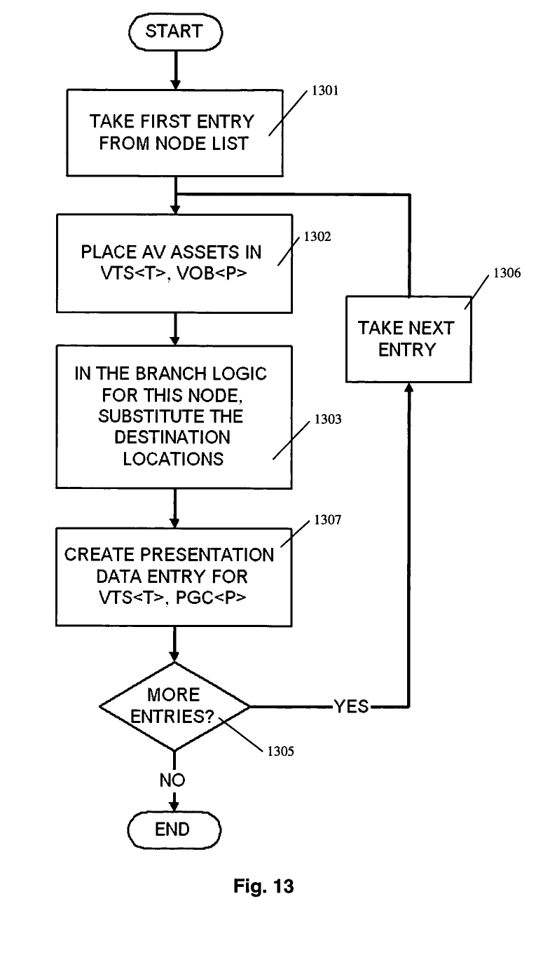

FIG. 15 shows a pair of text screens;

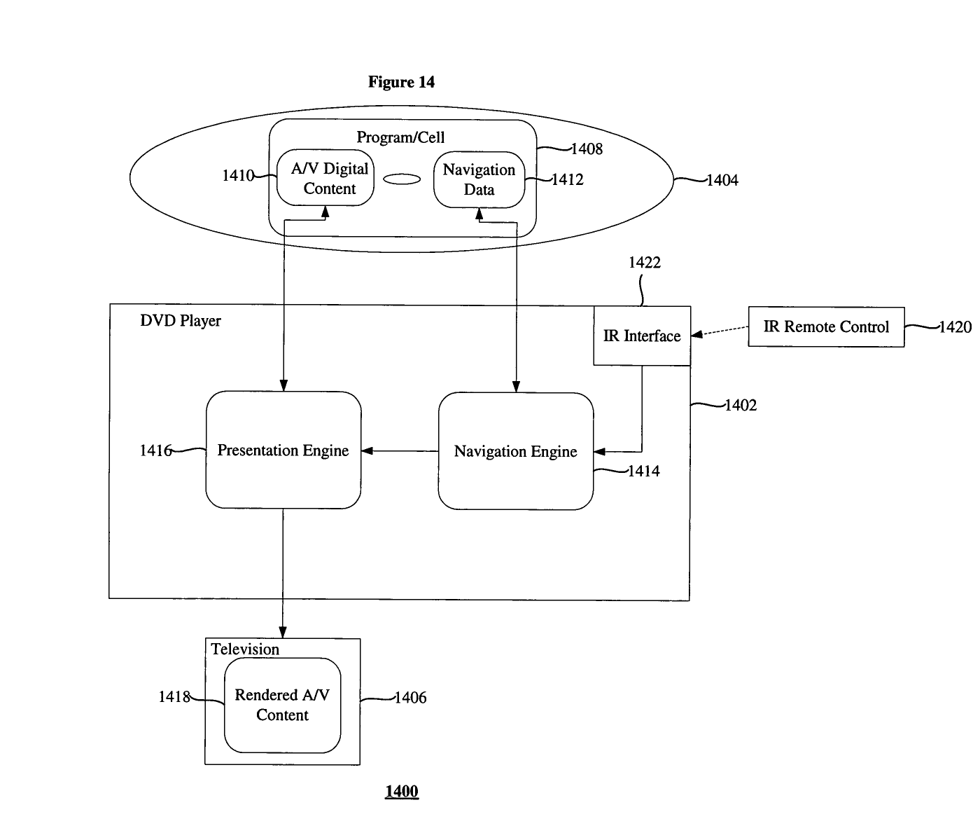

FIG. 16 illustrates relatively sophisticated scrolling performed by a computer;

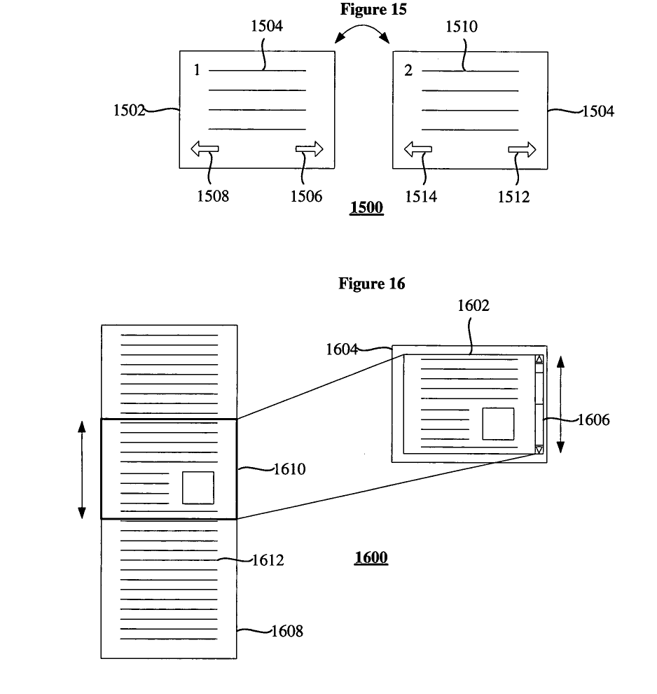

FIG. 17 shows, schematically, authoring of scrolling data sets according to an embodiment;

FIG. 18 illustrates the display of a number of scrolling data sets according to an embodiment;

FIG. 19 illustrates a flowchart for producing scrolling data sets;

FIG. 20 shows a flowchart for displaying digital AV content using scrolling data sets; and

FIG. 21 illustrates two-dimensional scrolling and the production of two-dimensional scrolling data sets.

FIG. 22 illustrates a process for producing sequence of video that emulates zooming.

### DETAILED DESCRIPTION OF THE PREFERRED EMBODIMENTS

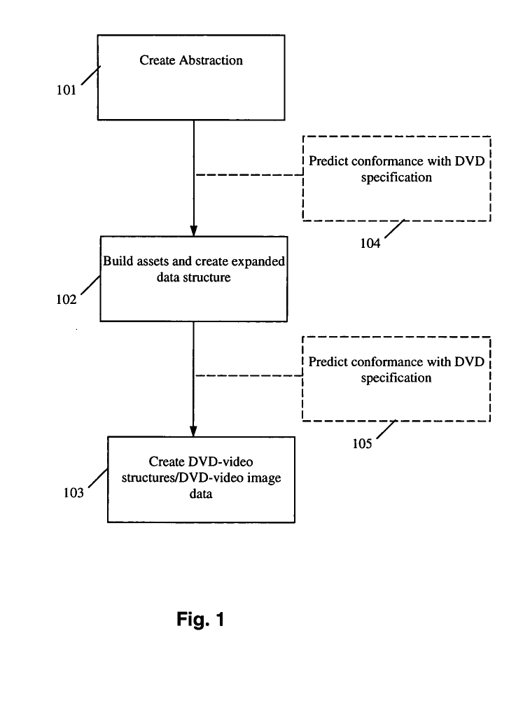

FIG. 1 shows an overview of an authoring method according to a preferred embodiment of the present invention. The embodiments of the present invention are applicable when authoring many types of audiovisual content or products, and in particular when complex navigational structure or content are involved.

As one example, embodiments of the present invention are applicable to authoring of video-on-demand products delivered remotely from a service provider to a user, such as over a computer network or other telecommunications network. Here, the embodiments of present invention are especially useful in authoring interactive products, where user choices and responses during playback of the product dictate navigational flow or content choices.

As another example, embodiments of the present invention are particularly suitable for use in the authoring of an audiovisual product or audio visual content compliant with a DVD-video specification. This example will be discussed in more detail below in order to illustrate the preferred arrangements of present invention. The audiovisual product can be, for example, recorded onto a medium such as an optical disk or magnetic medium. The DVD-video specification defines a series of data objects that are arranged in a hierarchical structure, with strict limits on the maximum number of objects that exist at each level of the hierarchy. Hence, in one preferred embodiment of the present invention it is desired to create an audiovisual product or audiovisual content which meets these and other limitations of the specification. In particular it is desired that the resultant audiovisual product will play on commonly available DVD players. However, it is also desired to create the audiovisual product having a complex navigational structure, to increase a user's enjoyment of the product, and in order to allow the creation of new categories of audiovisual products.

In the field of DVD-video, audiovisual content is considered in terms of audio-visual assets (also called AV assets or presentation objects) . According to the DVD-video specification each AV asset contains at least one video object, zero or more audio objects, and zero or more sub-picture objects. That is, a section of video data is presented along with synchronised audio tracks and optional sub-picture objects. The current DVD-video specification allows up to eight different audio tracks (audio streams) to be provided in association with up to nine video objects (video streams). Typically, the video streams represent different camera angles, whilst the audio streams represent different language versions of a soundtrack such as English, French, Arabic etc. Usually, only one of the available video and audio streams is selected and reproduced when the DVD-video product is played back. Similarly, the current specification allows up to thirty-two sub-picture streams, which are used for functions such as such as language subtitles. Again, typically only one of the sub-picture streams is selected and played back to give, for example, a movie video clip with English subtitles from the sub-picture stream reproduced in combination with a French audio stream. Even this relatively simple combination of video, audio and sub-picture streams requires a high degree of co-ordination and effort during authoring to achieve a finished product such as a feature movie. Hence, due to the laborious and expensive nature of the authoring process there is a strong disincentive that inhibits the development of high-quality audiovisual product according to the DVD-video specification. There is then an even stronger impediment against the development of audiovisual product with complex navigational flow or using high numbers of individual raw content objects.

Conveniently, the authoring methods of embodiments of the present invention are implemented as a program or a suite of programs. The program or programs are recorded or stored on or in any suitable medium, including a removable storage such as a magnetic disk, hard disk or solid state memory card, or as a signal modulated onto a carrier for transmission on any suitable data network, such as the Internet.

In use, the authoring method is suitably performed on a computing platform, like a general purpose computing platform such as a personal computer or a client-server computing network. Alternatively, the method may be implemented, wholly or at least in part, by dedicated authoring hardware.

As shown in FIG. 1, the authoring method of the preferred embodiment of the present invention comprises three main stages, namely: creating a high-level abstraction (or storyboard) representing functional sections of a desired audiovisual product in step 101; automatically evaluating the high-level abstraction to create a fully expanded intermediate structure and a set of AV assets in step 102; and creating an output data structure compliant with a DVD-video specification using the expanded intermediate structure and AV assets in step 103. Preferably, the output data structure can then recorded onto a recording medium, such as, for example, a digital linear tape that can be used, to create a DVD-video product using glass master created using the content of the digital linear tape.

The method outlined in FIG. 1 will now be explained in more detail.

Firstly, looking at the step 101 of FIG. 1, the high-level abstraction is created by forming a plurality of components that implicitly represent functional elements of a desired DVD-video product, and a set of transitions that represent movements, that is, navigation, between the components that will occur during playback.

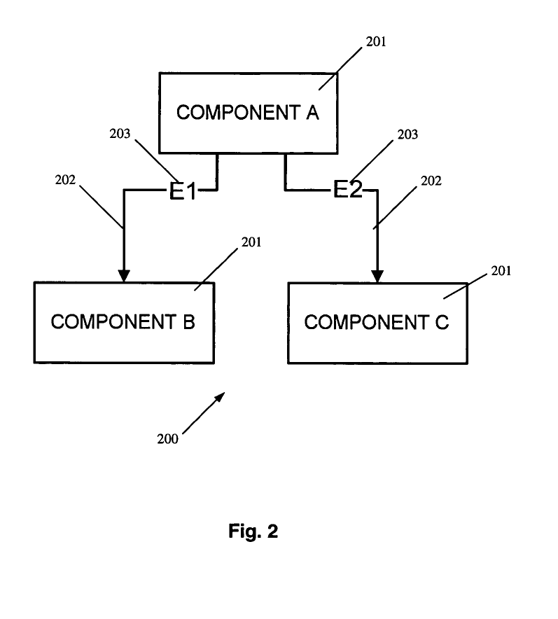

FIG. 2 is a schematic diagram showing a simple abstraction of a desired audiovisual product. In the example of FIG. 2 there are three components 201, linked by two transitions 202. The components 201 represent functional elements of the desired audiovisual product, where one or more portions of AV content (combinations of video clips, audio clips, etc) are to be reproduced during playback. The transitions 202 indicate legitimate ways of moving from one component to another during playback. In the example of FIG. 2, the transitions 202 are all explicitly defined. Suitably, each transition 202 is associated with an event 203, which indicates the circumstances giving rise to that transition. An event 203 is a triggering action such as the receipt of a user command, or the expiry of a timer, that influences movement through the sections of AV content during playback. Referring to FIG. 2, starting from a particular component A, and given all possible actions, exactly one event 203 will be satisfied, allowing a transition 202 from the current component A to a next component B or C.

The preferred embodiments provide three different types of component. These are an information component, a choice component and a meta-component.

An information component represents what will in due course become a single AV asset in the desired audiovisual product. Suitably, an information component simply comprises a reference to a raw content object or collection of raw content objects (i.e. raw video and audio clips, image stills or other digital content) that will be used to create an AV asset in the audiovisual product. For example, an information component refers to a welcome sequence that is displayed when the DVD-video product is played in a DVD-video player. The same welcome sequence is to be played each time playback begins. It is desired to display the welcome sequence, and then proceed to the next component. An information component (which can also be termed a simple component) is used principally to define presentation data in the desired DVD-video product.

A choice component represents what will become a plurality of AV assets in the desired audiovisual product. In the preferred embodiment, the choice component (alternately termed a multi-component) comprises a reference to at least one raw content object, and one or more parameters. Here, for example, it is desired to present a welcome sequence in one of a plurality of languages, dependent upon a language parameter. That is, both a speaker's picture (video stream) and voice track (audio stream) are changed according to the desired playback language. Conveniently, a choice component is used to represent a set of desired AV assets in the eventual audiovisual product, where a value of one or more parameters is used to distinguish between each member of the set. Hence, a choice component represents mainly presentation data in a desired DVD-video product, but also represents some navigational structure (i.e. selecting amongst different available AV assets according to a language playback parameter).

A meta-component comprises a procedurally-defined structure representing a set of information components and/or a set of choice components, and associated transitions. Conveniently, a meta-component may itself define subsidiary meta-components. A meta-component is used principally to define navigational structure in the desired audiovisual product by representing other components and transitions.

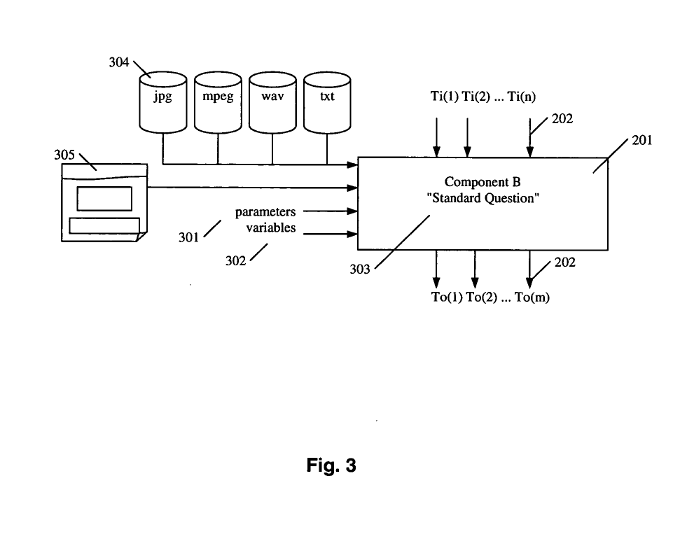

FIG. 3 shows a choice component or information component 201 in more detail. The component is reached by following one of a set of incoming transitions 202, labelled Ti(1 . . . n), and is left by following one of a set of outgoing transitions To(1 . . . m). The set of incoming transitions 202 might comprise one or more than one incoming transition. The set of outgoing transitions might comprise one or more than one outgoing transition.

The component 201 is defined with reference to zero or more parameters 301, which are used only during the authoring process. However, the component 201 may also be defined with reference to zero or more runtime variables 302. Each variable 302 records state information that can be read and modified within the scope of each component, during playback of the audiovisual product such as in a standard DVD player. Conveniently, the component 201 is provided with a label 303 for ease of handling during the authoring process.

The component 201 contains references to one or more items of content 304. The items of content are raw multi-media objects (still picture images, video clips, audio clips, text data, etc.) recorded in one or more source storage systems such as a file system, database, content management system, or asset management system, in any suitable format such as, for example,. gif, .tif, .bmp, .txt, .rtf, .jpg,. mpg, .qtf, .mov, .wav, .rm, .qtx, amongst many others. It will be appreciated that these raw content objects are not necessarily at this stage in a format suitable for use in the DVD-video specification, which demands that video, audio and sub-picture objects are provided in selected predetermined formats (i.e. MPEG).

Each component 201 uses the references as a key or index which allows that item of content to be retrieved from the source storage systems. The references may be explicit (e.g. an explicit file path), or may be determined implicitly, such as with reference to values of the parameters 301 and/or variables 302 (i.e. using the parameters 301 and/or variables 302 to construct an explicit file path).

Conveniently, the component 201 also preferably comprises a reference to a template 305. The template 305 provides, for example, a definition of presentation, layout, and format of a desired section of AV content to be displayed on screen during playback. A template 305 draws on one or more items of content 304 to populate the template. Typically, one template 305 is provided for each component 201. However, a single template 305 may be shared between a number of components 201 or vice versa. A template 305 is provided in any suitable form, such as, for example. As an executable program, a plug-in or an active object. A template is conveniently created using a programming language such as C++, Visual Basic, Shockwave or Flash, or by using a script such as HTML or Python, amongst many others. Hence, it will be appreciated that a template allows a high degree of flexibility in the creation of AV assets for a DVD-video product. Also, templates already created for other products (such as a website) may be reused directly in the creation of another form of audiovisual product, in this case a DVD-video product content.

The parameters 301, runtime variables 302, content items 304 and template 305 together allow one or more AV assets to be produced for use in the desired audiovisual product. Advantageously, creating a component 201 in this parameterised form allows a number, which might be a large number, large plurality of AV assets to be represented simply and easily by a single component.

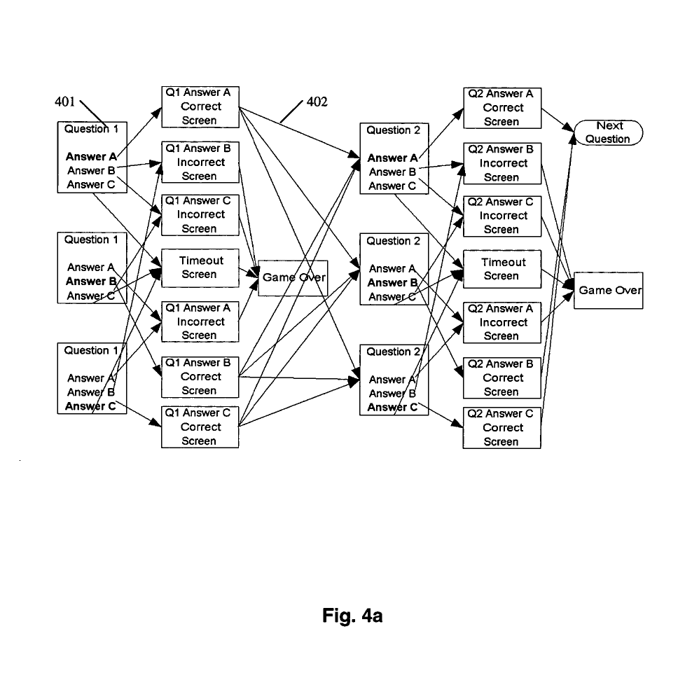

To illustrate the power and advantages of creating components 201 and transitions 202 as described above, reference will now be made to FIG. 4 which compares a typical prior art method for authoring an audiovisual product against preferred embodiments of the present invention. In this example, it is desired to develop an audiovisual product which allows the user to play a simple quiz game.

In FIG. 4a, each AV asset 401 which it is desired to present in the eventual audiovisual product must be created in advance and navigation between the assets defined using navigation links represented by arrows 402. Here, the game involves answering a first question and, if answered correctly, then answering a second question. The answer to each question is randomised at runtime using a runtime variable such that one of answers A, B and C is correct, whilst the other two are incorrect. In this simple example of FIG. 4a it can be seen that a large number of assets need to be created, with an even greater number of navigational links. Hence, the process is relatively expensive and time consuming, and is prone to errors.

FIG. 4b shows an abstraction, using components and transitions as described herein, for an equivalent quiz game. It will be appreciated that the abstraction shown in FIG. 4b remains identical even if the number of questions increases to ten, twenty, fifty or some other number of questions, whereas the representation in FIG. 4a becomes increasingly complex as each question is added.

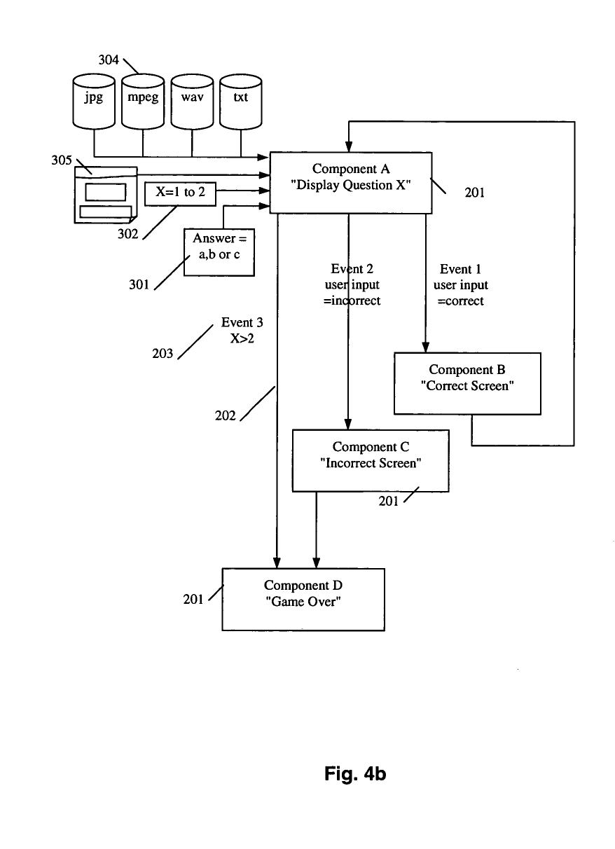

FIG. 5 shows another example abstraction using components and transitions. FIG. 5 illustrates an example abstraction for an audiovisual product that will contain a catalogue of goods sold by a retail merchant. A welcome sequence is provided as an information component 201a. Choice components 201b are used to provide a set of similar sections of AV content such as summary pages of product information or pages of detailed product information including photographs or moving video for each product in the catalogue. Here, the catalogue contains, for example, of the order of one thousand separate products, each of which will result in a separate AV asset in the desired DVD-video product. Meta-components 201c provide functions such as the selection of products by category, name or by part code. These meta-components are procedurally defined.

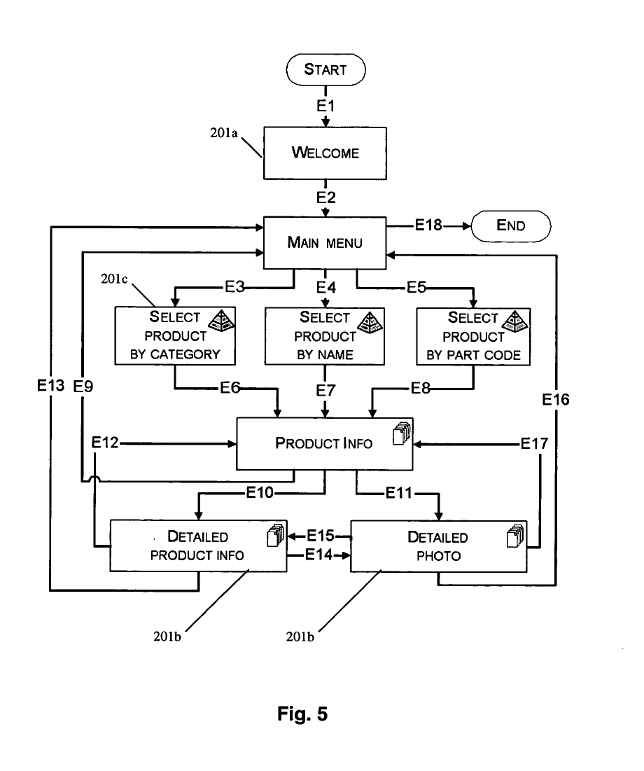

FIG. 6 shows a tabular representation for the abstraction shown in schematic form in FIG. 5.

In use, the authoring method and apparatus suitably presents a convenient user interface for creating components and transitions of the high-level abstraction. Ideally, a graphical user interface is provided allowing the definition of components, transitions and events, similar to the schematic diagram of FIG. 5. Most conveniently, the user interface provides for the graphical creation of components such as by drawing boxes and entering details associated with those boxes, and defining transitions by drawing arrows between the boxes and associating events with those arrows. Alternatively, a tabular textual interface is provided similar to the table of FIG. 6.

Referring again to FIG. 1, the abstraction created in step 101 is itself a useful output. The created abstraction may be stored for later use or may be transferred to another party for further work. However, in most cases the authoring method is used to automatically create a final audiovisual product, such as a DVD-video product, from the abstraction.

Referring to FIG. 1, the method optionally includes the step 104 of checking for compliance with a DVD specification. It is desired to predict whether the resulting DVD-video product will conform to a desired output specification, in this case the DVD-video specification. For example, the DVD-video specification has a hierarchical structure with strict limits on a maximum number of objects that may exist at each level, and limits on the maximum quantity of data that can be stored on a DVD-video disc.

In one embodiment, the checking step 104 is performed using the created components 201 and transitions 202. As discussed above, the components 201 contain references to raw AV content objects 304 and templates 305, and authoring parameters 301, 302, that allow AV assets to be produced. The checking step 104 comprises predicting a required number of objects at each level of the hierarchical structure, by considering the number of potential AV assets that will be produced given the possible values of the authoring parameters (i.e. authoring-only parameters 301 and runtime variables 302), and providing an indication of whether the limits for the maximum number of objects will be exceeded. Similarly, where a component defines a set of similar AV assets, then it is useful to predict the physical size of those assets and to check that the audiovisual product is expected to fit within the available capacity of a DVD disc. Advantageously, the conformance check of step 104 is performed without a detailed realisation of every AV asset, whilst providing an operator with a reasonably accurate prediction of expected conformance. If non-conformance is predicted, the operator may then take steps, at this early stage, to remedy the situation. As a result, it is possible to avoid unnecessary time and expense in the preparation of a full audiovisual product which is non-conformant.

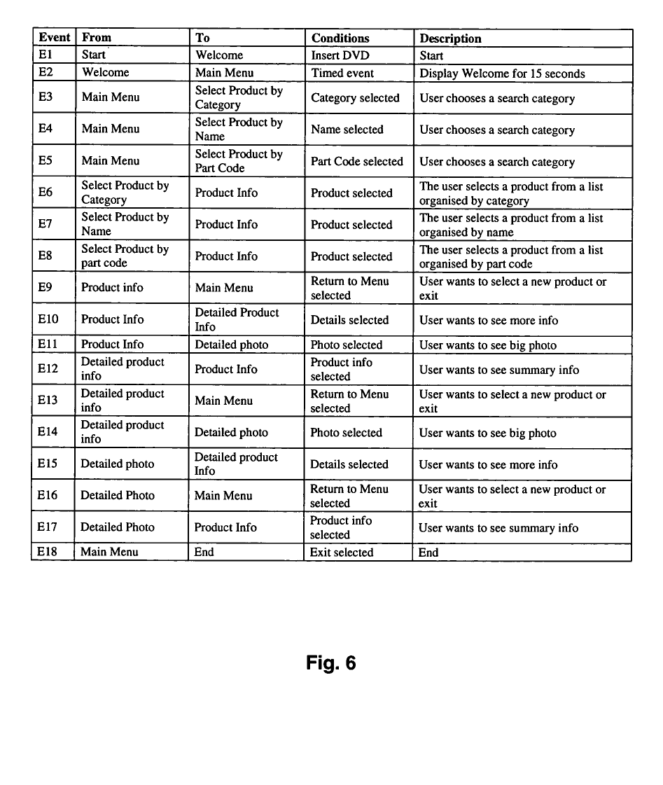

As shown in FIG. 1, in step 102 the components 201 and transitions 202 of the high level abstraction 200 are automatically evaluated and expanded to create AV assets and an intermediate data structure of nodes and links. FIG. 7 shows the step 102 of FIG. 1 in more detail.

The components 201 and transitions 202 may be evaluated in any order. However, but it is convenient to first evaluate the components and then to evaluate the transitions. Ideally, any meta-components in the abstraction are evaluated first. Where a meta-component results in new components and transitions, these are added to the abstraction until all meta-components have been evaluated, leaving only information components and parameterised choice components.

An expanded intermediate data structure is created to represent the abstract components 201 and transitions 202 in the new evaluated form. This expanded data structure comprises branching logic derived from the events 203 attached to the transitions 202 (which will eventually become navigation data in the desired audiovisual product) and nodes associated with AV assets derived from the components 201 (which will eventually become presentation data in the audiovisual product). However, it is not intended that the expanded data structure is yet in a suitable form for creating an audiovisual product in a restricted format such as a DVD-video product, since at this stage there is no mapping onto the hierarchical structure and other limitations of the DVD-video specification.

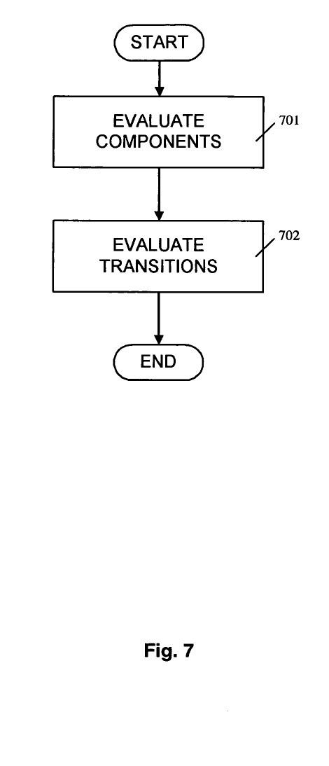

FIG. 8 shows step 701 of FIG. 7 in more detail, to explain the preferred method for evaluating the components 201. As shown in FIG. 8, each information component 201a and each choice component 201b is selected in turn in step 801. Each component 201 is evaluated to provide one or more AV assets in step 802. In an information component, this evaluation comprises creating an AV asset from the referenced raw content objects 304. In a choice component, this evaluation step comprises evaluating a template 305 and one or more raw content objects 304 according to the authoring parameters 301/302 to provide a set of AV assets. Suitably, a node in the expanded data structure is created to represent each AV asset, at step 803. At step 804, entry logic and/or exit logic is created to represent a link to or from each node such that each AV asset is reached or left under appropriate runtime conditions.

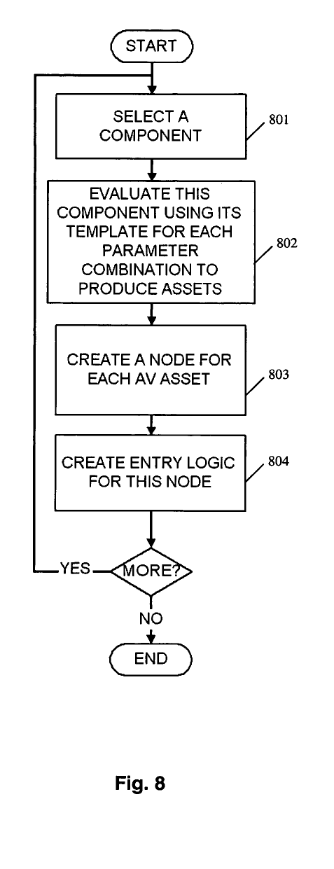

FIG. 9 shows a preferred method for evaluating transitions in step 702 of FIG.7. Each transition 202 is selected in any suitable order in step 901. In step 902 the conditions of the triggering event 203 associated with a particular transition 202 are used to create entry and/or exit logic for each node of the expanded data structure. In step 903, explicit links are provided between the nodes.

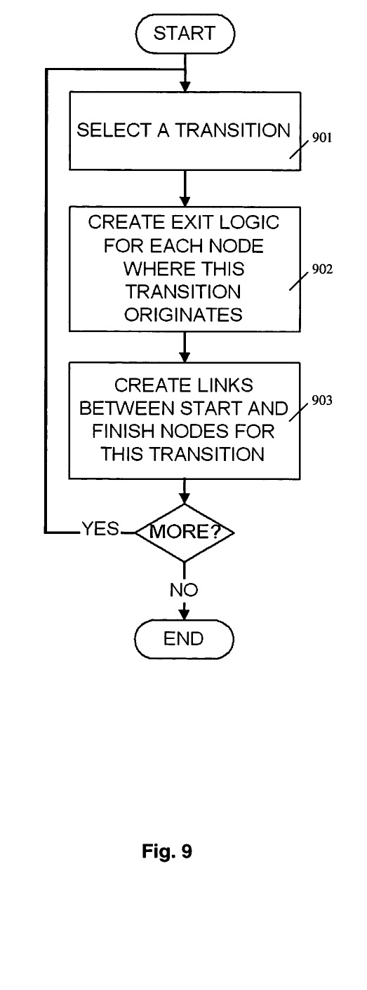

FIG. 10 is a schematic illustration of a component 201 during evaluation to create a set of nodes 110 each associated with an AV asset 120, together with entry logic 132 and exit logic 134, defining movement between one node 110 and the next. The entry logic 132 and exit logic 134 reference runtime variables 302 which are available during playback (e.g. timer events, player status, and playback states), and the receipt of user commands. Conveniently, the evaluation step consumes each of the authoring-only parameters 301 associated with the abstract components 201, such that only the runtime variables 302 and runtime actions such as timer events and user commands remain.

Referring again to FIG. 1, a conformance checking step 105 may, additionally or alternatively to the checking step 104, be applied following the evaluation step 102. Evaluation of the abstraction in step 102 to produce the expanded data structure 100 allows a more accurate prediction of expected compliance with a particular output specification. In particular, each node of the expanded data structure represents one AV asset, such that the total number of AV assets and object locations can be accurately predicted, and the set of AV assets has been created, allowing an accurate prediction of the capacity required to hold these assets. Conveniently, information about conformance or non-conformance is fed back to an operator. Changes to the structure of the product can then be suggested and made in the abstraction to improve compliance.

Referring to FIG. 1, in step 103 the expanded data structure from step 102 is used to create an audiovisual product according to a predetermined output format, in this case by creating specific structures according to a desired DVD-video specification.

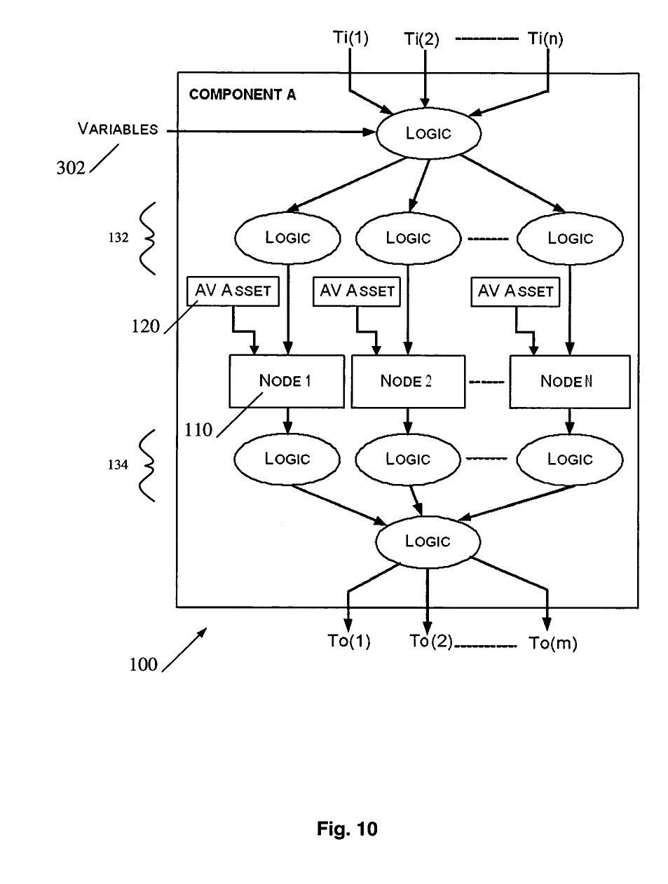

FIG. 11 shows an example method for creation of the DVD video structures. In step 1101, the nodes 110 in the expanded data structure are placed in a list, such as in an order of the abstract components 201 from which those nodes originated, and in order of the proximity of those components to adjacent components in the abstraction. As a result, jumps between DVD video structure locations during playback are minimised and localised to improve playback speed and cohesion.

Each node is used to create a DVD video structure location at step 1102. Optionally, at step 1103 if the number of created DVD video structure locations exceeds the specified limit set by the DVD-video specification then creation is stopped at 1104 and an error reported. Assuming the number of structures is within the specified limit then DVD video compatible data structures are created at step 1105. Finally, a DVD video disc image is created at step 1106. Conveniently, commercially available tools are used to perform step 1106 and need not be described in detail here.

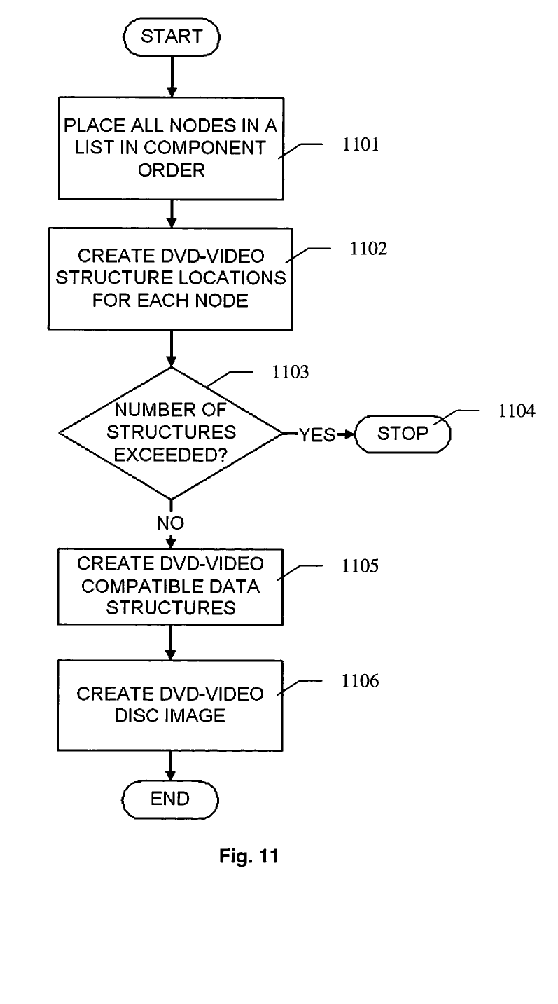

Step 1102 is illustrated in more detail in FIG. 12. In this example variable T represents a number of a video title set VTS (ie. from 1-99) whilst variable P represents a program chain PGC (ie. from 1-999) within each video title set. As shown in FIG. 12, the nodes 110 of the expanded data structure 100 are used to define locations in the video title sets and program chains. As the available program chains within each video title set are consumed, then the locations move to the next video title set. Here, many alternate methods are available in order to optimise allocation of physical locations to the nodes of the expanded data structure.

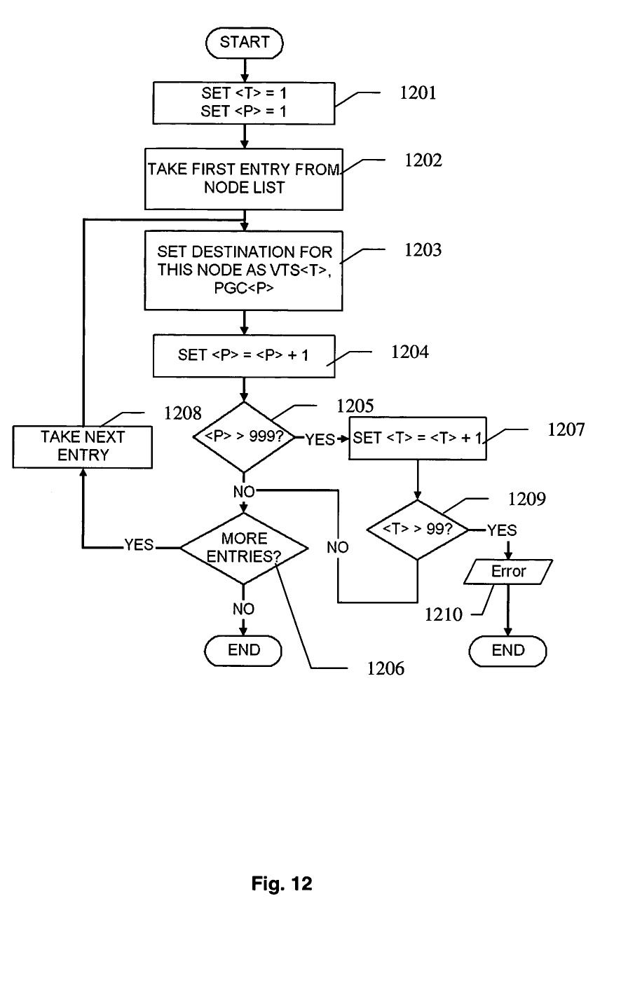

Step 1105 of FIG. 11 is illustrated in more detail in FIG. 13. FIG. 13 shows a preferred method for creating DVD-video compatible data structures by placing the AV assets 120 associated with each node 110 in the structure location assigned for that node and substituting links between the nodes with explicit references to destination locations. At step 1307 this results in an explicit DVD compatible data structure which may then be used to create a DVD disc image. Finally, the DVD disc image is used to record a DVD disc as a new audiovisual product.

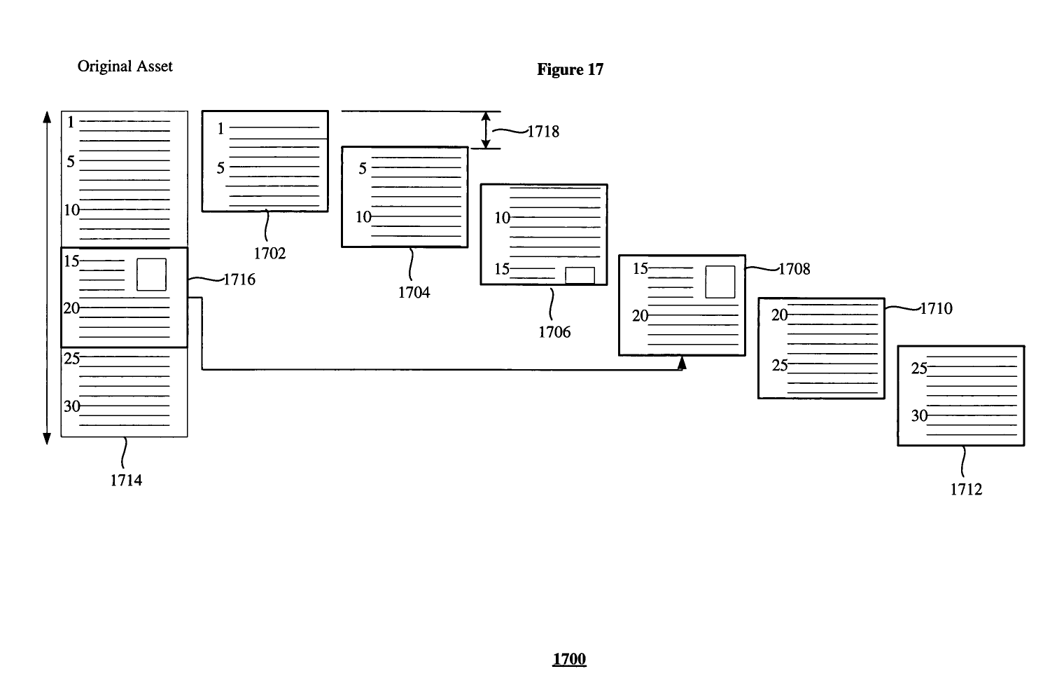

Referring to FIG. 17 there is shown schematically an authoring process 1700 for producing a number of stills or frames 1702 to 1712 from a document 1714 intended to be presented by the navigation engine 114 of a DVD player 102 in response to controls received from the infrared remote control 120. It will be appreciated that the document represents a realisation of a raw content object described above. The document 1714 represents an embodiment of a static or original visual asset. The stills 1702 to 1712 represent at least part of a set of visual assets for use in producing an optical medium based product, such as, for example, a DVD product. A moveable window 1716 is arranged to traverse the document 1714, according to a pre-defined step size 1718, to produce each of the stills or frames 1702 to 1712. When each of the stills or frames 1702 to 1712 are retrieved and presented by the presentation engine 1416 they will give the impression to the user of the DVD player 1402 that the DVD player is scrolling through the document 1714 in real-time even though no real-time processing comparable with that undertaken by a computer is performed. The data required to emulate such scrolling is pre-authored or pre-calculated, that is, it is determined in advance. The pre-authored data represent a realisation or raw content objects.

Within the user interface presented by the authoring tool, there is a “1D scroll” component, which represents a scroll action or implementation. The “1D scroll” component would preferably be implemented as a meta-component and would be parameterised with a file name, image file, some other source file or reference to source content that corresponds to a document or content to be scrolled. Preferably, other parameters or aspects of the scroll operation would also be parameterised such as, for example, speed of scrolling, percentage of overlap between consecutive scrolled sections etc.

During the authoring process, such a meta-component representing a scrolling operation or action would be expanded into many nodes and links. Each node would correspond to an individual animated scrolling sequence, and the links would connect those nodes together so that adjacent scrolling sequences are connected appropriately. Thus, in this expansion process, the original data, for example, an image file, would be used as source material to create a number of animated sequences, each sequence representing part of the overall document scroll.

It will be appreciated that as the step size 1718 decreases, the smoothness of the result in scrolling increases.

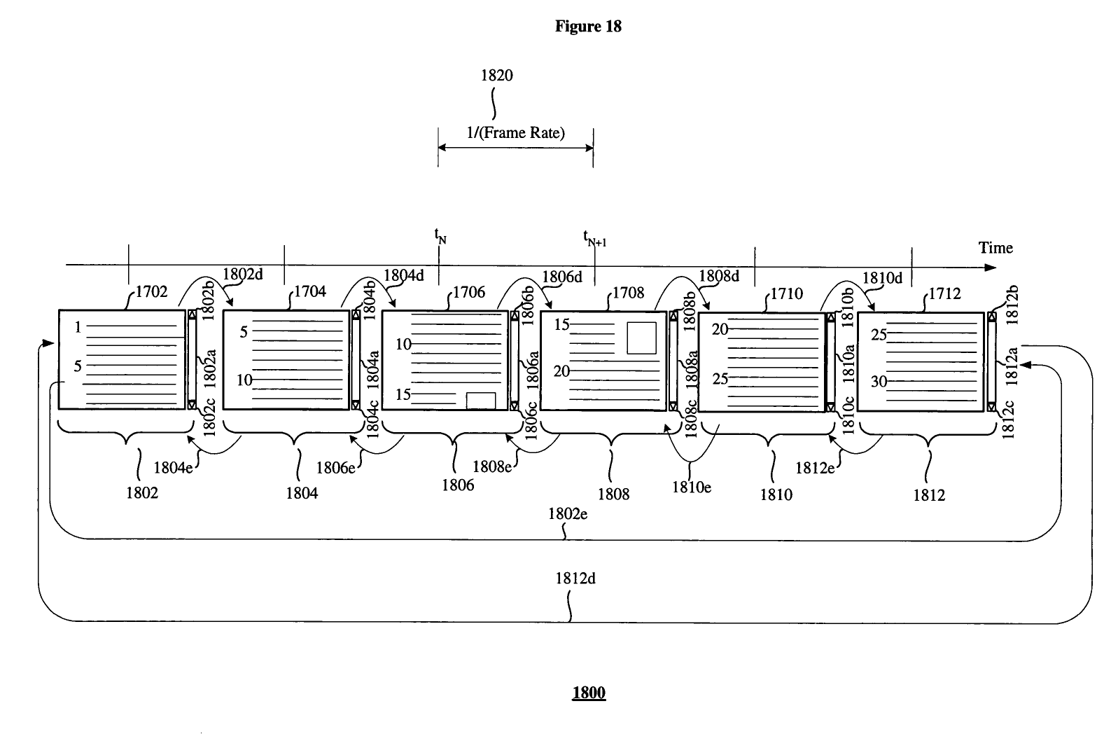

Each of the extracted stills or frames 1702 to 1712 are used to produce corresponding scrolling data sets 1802 to 1812 as shown in FIG. 18. For each scrolling data set 1802 to 1812, a scroll bar graphic 1802a to 1812a is also produced. Each scroll bar graphic 1802a to 1812a comprises up arrow menu options 1802b to 1812b and down arrow menu options 1802c to 1812c that are recorded and presented as sub-picture data of the digital content 1410. Associated with each scrolling data set 1802 to 1812 is corresponding navigation data that points to a preceding or succeeding still or frame 1702 to 1712. The corresponding navigation data used to retrieve a preceding or succeeding frame is determined according to which of the arrows 1802b to 1812b and 1802c to 1812c have been actuated or selected by the user using their remote control 1420. The navigation data comprises a number of forward links 1802d to 1810d and a number of backward links 1812e to 1804e to allow the user to scroll through, that is, select, the various stills 1702 to 1712 represented by data recorded on the DVD 1404. It will be appreciated that the navigation data each represent a realisation of the data of the expanded intermediate structure of nodes and links. Once the user has reached a start or end screen such as, for example, stills 1702 and 1702 respectively, the sub-picture menu data can be arranged such that the stills 1702 to 1712 present a “wrapped-around” document. If an embodiment intends to present a “wrapped-around” document, corresponding navigation data 1812d and 1802e is required. Alternatively, the sub-picture menu data can be modified to indicate that one can only traverse forwards and backwards between the start 1702 and end 1712 stills by removing the backwards and forwards menu options from the start 1702 and end 1712 stills respectively.

It will be appreciated that each of the generated stills 1702 to 1712 represent, at least in part, transition data for giving effect to scrolling.

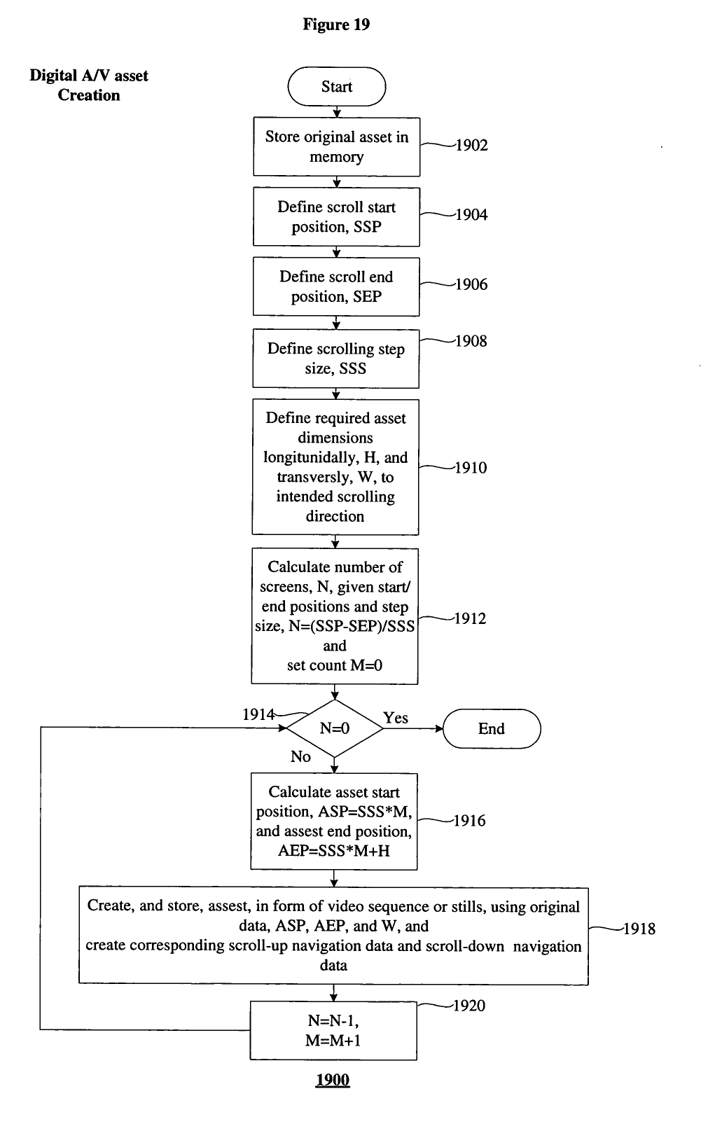

Referring to FIG. 19, there is shown a flowchart 1900 of the processing involved in an authoring method according to an embodiment. The original asset such as, for example, the text document 1714, is stored in memory (not shown) at step 1902. A scroll start position, SSP, is defined in step 1904. For example, in one embodiment the scroll start position may correspond to the first row of pixels of the scrolling window 1716 when it is in a position that corresponds to still or frame 1702. At step 1906, a scroll end position SEP, is defined. For example, in the first embodiment, the scroll end position corresponds to the first row of pixels defined by the window 1716 when in a position corresponding to the last still or frame 1712. However, in second embodiment, the scroll end position might correspond to the first row of pixels of the window 1716 when it is in a position corresponding to the second still or frame 1704. The choice of which embodiment one skilled in the art realises depends upon the required scrolling smoothness or resolution.

A scrolling step size, SSS, is defined at step 1908. The scrolling step size also influences the smoothness or resolution of any resulting scrolling. Longitudinal, H, and transverse, W, visual asset dimensions are defined at step 1910. The number, N, of stills or frames required to give effect to scrolling between the scroll start position, SSP, and the scroll end position, SEP, is calculated at step 1912. Also, a count, M, that is used to keep track of the number of assets or frames produced so far is set to zero at step 1912.

A test is made, at step 1914, to determine whether N=0. If it is determined that N is equal to zero, the visual asset creation process shown by the flowchart 1900 is terminated. However, if it is determined that N is not equal to zero, the asset start position, ASP, and asset end position, AEP, are calculated at step 1916. It will be appreciated that the longitudinal and transverse dimensions effectively correspond to the dimensions of the moveable window 1716 used to produce the assets. A current asset to be created is produced and stored using the original data 1714, the asset start position, the asset end position together with the window 1716 or asset dimensions, H and W, at step 1918. Also created, at step 1918, are the corresponding scroll bar graphics 1802a to 1812a together with appropriate forwards navigation data 1802d to 1812d and backwards navigation data 1812e to 1802e. At step 1920, the number, N, of screens or assets to be created is reduced by one and the count, M, is increased by one.

It will be appreciated that the flowchart 1900 shown in FIG. 19 allows the data used in implementing or emulating the scrolling to be produced in advance and automatically. These pre-authored scrolling data sets can be used in the creation of a digital linear tape in preparation for producing the DVD product. It will be appreciated that each created asset 1702 to 1712 might be stored, on the resulting DVD product, as a GOP with an MPEG sequence code, which provides an indication to the navigation 1414 and presentation engines 1416 that the data representing the asset should presented as a still.

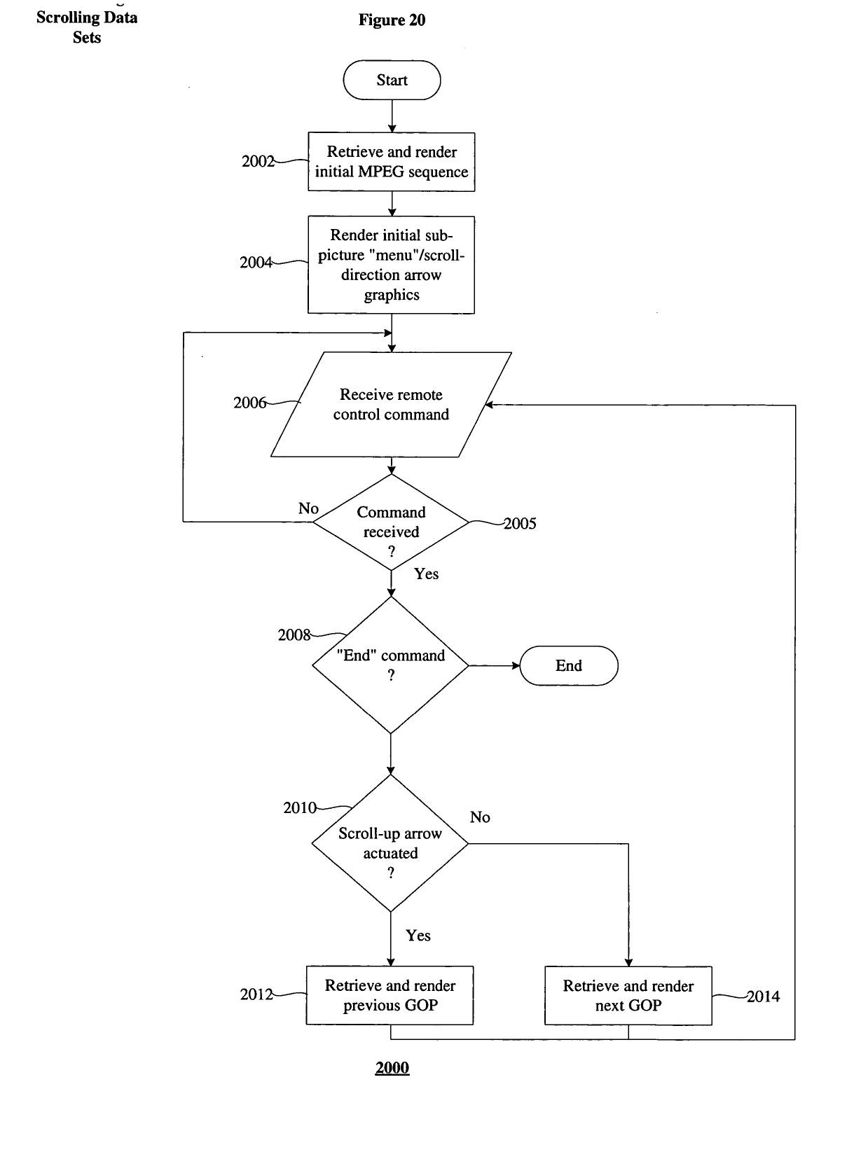

Referring to FIG. 20 there is shown a flowchart 2000 for rendering the scrolling data sets 1802 to 1812. At step 2002, the initial data set or GOP, with an MPEG sequence code, is retrieved and rendered. Also, the corresponding initial sub-picture “menu” or scroll direction arrow graphics 1802b to 1812b and 1802c to 1812c are retrieved and rendered at step 2004. The navigation engine 1414 then awaits receipt of a control command from the infrared remote control 1420 at step 2005. Such a command is shown as having been received at step 2006 in the flow chart 2000. It is determined, at step 2008, whether the command is an “end” command. If the command is an “end” command the process for rendering the scrolling data sets is terminated. It will be appreciated that within this context an “end” command represents a command that indicates a desire to perform some processing or activity other than continued scrolling. At step 2010, it is determined whether the command represents a selection of the menu item represented by a scroll-up arrow and, therefore, represents actuation of the scroll-up arrow 1802b to 1812b. If it is determined, at step 2010, that the scroll-up arrow has been actuated, the navigation engine 1414, using the appropriate navigation data 2012e to 2002e, retrieves the “previous” or preceding still or frame 1702 to 1712 at step 2012. However, if it is determined that the scroll-up arrow has not been actuated, it is assumed that the scroll-down arrow has been actuated and the next or succeeding still or frame 1702 to 1712 is retrieved and rendered at step 2014. Processing then returns to step 2005.

Although the above embodiment has been described with reference to calculating scrolling data sets using the pre-defined steps size 1718 to produce the stills or frames 1702 to 1712, embodiments of the present invention are not limited to such an arrangement. Embodiments can be realised in which each of the stills or frames 1702 to 1712 represent start and end frames for a scrolling operation and a number of frames are calculated and produced using the sliding window 1716 to give effect to a transition between any given pair of start and end frames. It will be appreciated that the smoothness, as perceived by the user, of the scrolling between any given pair of start and end frames will be or, at least can be, significantly greater than corresponding scrolling using the frames or stills 1702 to 1712 depending on the step size 1718 selected.

The above embodiment has been illustrated with reference to scrolling up and down through the document 1714 for the purpose of illustration only and is convenient given the type of text-based document to be scrolled through used to illustrate embodiments of the invention. It will be appreciated that embodiments of the present invention are not limited to scrolling up and down. Embodiments can be realised in which scrolling is effected sideways, that is, left and right. It will be appreciated that such left and right scrolling might be appropriate when viewing a document that is more properly represented horizontally such as a landscape document showing a panoramic view. Therefore, the scrolling data sets produced by embodiments of the present invention can also be arranged to produce left and right, or sideways, scrolling together with appropriate scroll arrow graphics and navigation data either alone, in the case of a panoramic view or document having a single screen height, or in conjunction with the up and down scrolling menu graphics and corresponding navigation data in the case of a document that is both wider and higher than the 720×480 or 720×576 pixels of DVD NTSC and DVD PAL/SECAM pixel resolutions respectively. It will be appreciated that in the latter case, embodiments of the present invention produce 2-dimensional scrolling data sets and allow 2-dimensional scrolling to be realised.

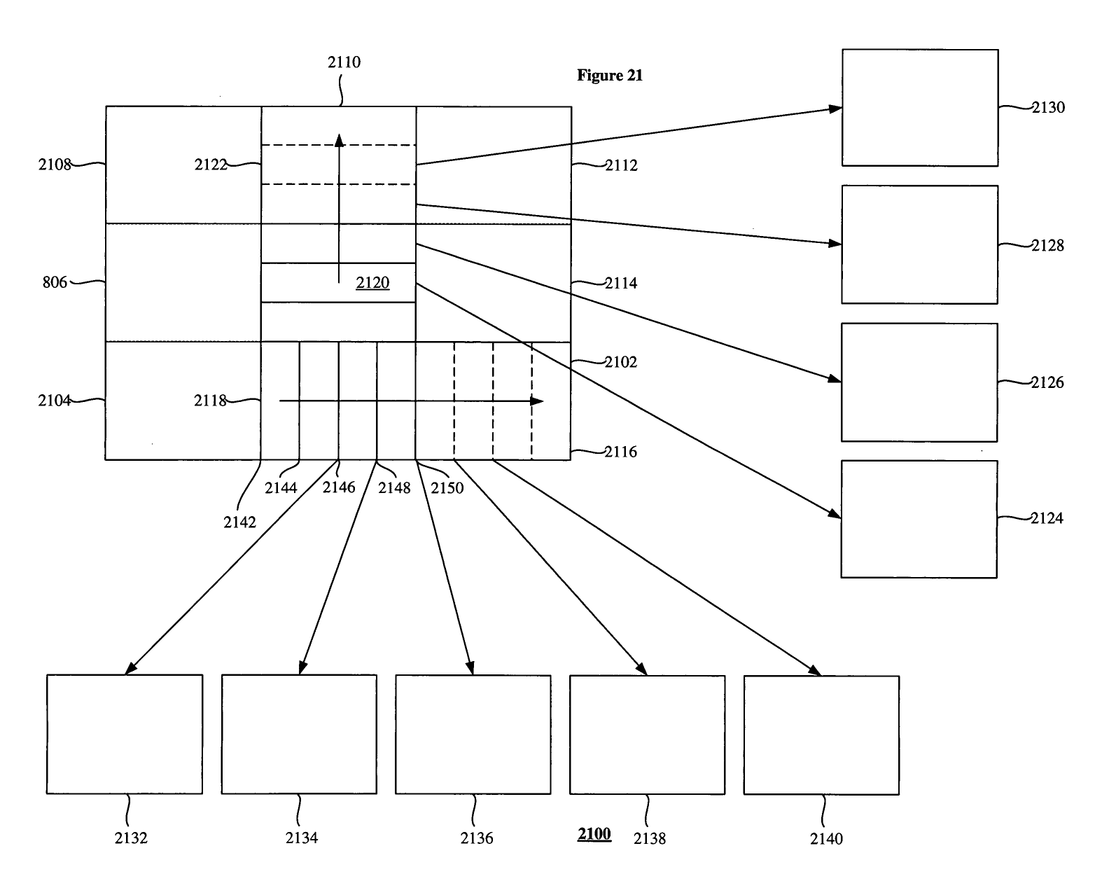

FIG. 21 shows schematically the production 2100 of 2-dimensional scrolling data sets. FIG. 21 depicts an initial or original image document 2102, which is notionally divided into 9 regions 2104 to 2122 that can be used to display respective parts of the overall image 2102. Although the embodiment has been illustrated using 9 regions, the present invention is not limited to such an arrangement. Embodiments can be realised in which any predetermined number of regions is used.

The visual assets required for vertical scrolling are produced in substantially the same manner as the stills or frames 1702 to 1712 were produced for one-dimensional scrolling. It can be appreciated that a transition from the central region 2102 to a central upper region 2120 has been shown as requiring the production of four stills or frames 2124 to 2130. The initial frame 2124 contains data corresponding to the data contained within the central portion 2102. The final frame 2130 of the transition contains data corresponding to that contained within the upper central portion 2122 of the image 2102. The remaining frames 2126 and 2128 are produced according to a desired step size as a notional window (not shown) traverses the image 2102 from the initial position at the central portion 2120 to the final position of the upper central portion 2122. Again, it will be appreciated that the smoothness or resolution of the scrolling is governed by the step size. The smaller the step size, the greater the number of visual assets that will be produced. Alternatively, as with the above embodiment, the four stills or frames 2124 to 2130 might represent intermediate scrolling positions for an overall transition from the central portion 2120 to the upper central portion 2122. For each set of adjacent pairs of those intermediate positions such as, for example, positions 2126 and 2128, a number of intermediate visual assets can be calculated. It will be appreciated that the flowcharts shown in FIGS. 19 and 20 are as applicable to vertical scrolling given an initial asset size that is wider than a desired asset size as they were to FIG. 18 in which the desired asset size was the same width as the original asset.

FIG. 21 also illustrates the production of horizontal scrolling data sets. In the case of horizontal scrolling it can be appreciated, again for the purpose of illustration only, that the initial starting position is shown as being the bottom central portion 2118 of the overall image 2102 and the end position is shown as being the lower right portion 2116 of the overall image 2102. The illustrated five stills or frames 2132 to 2140 are produced using corresponding start positions 2142 to 2150 for a notional window (not shown) as it progressively traverses the original asset 2102 according to a respective step size. Again, it will be appreciated that the flowcharts showing FIGS. 19 and 20 are equally applicable to horizontal scrolling. However, in the flowchart 1900 shown in FIG. 19 the asset start and end positions are calculated using W rather than H. In flowchart 2000 shown in FIG. 20, the test performed at step 2010 is arranged to determine whether the left arrow of any scroll direction arrow graphics, presented as sub-picture menu items, has been actuated rather than the scroll-up arrow.

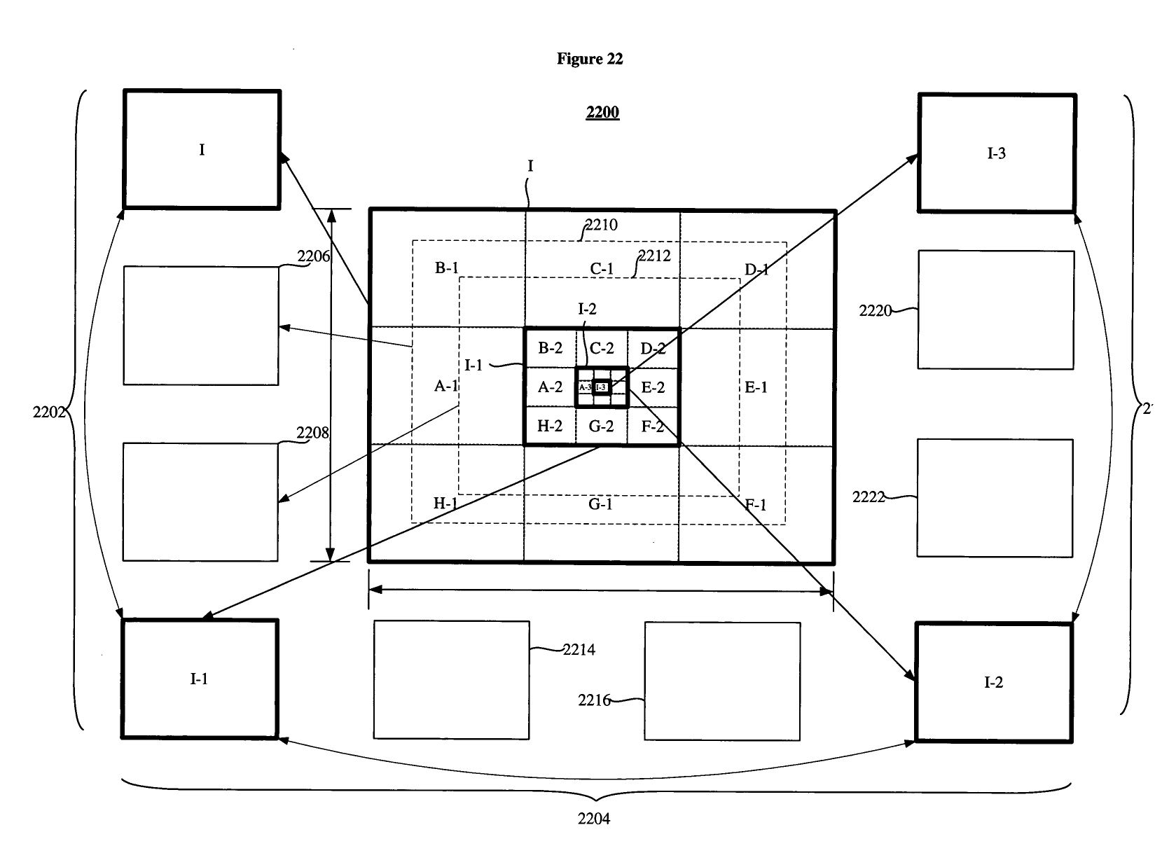

Referring to FIG. 22 there is illustrated a process 2200 for producing sequence of video that emulates zooming, that is, that gives the impression to the use of the DVD that they are controlling zoom-in and zoom-out functions. FIG. 22 comprises a central image I that is notionally divided into predetermined number of regions. In the illustrated example the image I has been divided into 9 regions that are labelled A-1 to I-1. It will be appreciated that the central portion I-1 is shown as being sub divided into 9 further notional regions A-2 to I-2. Similarly each of the other first-level notional regions A-1 to H-1 can also be divided into 9 second-level notional regions A-1, A-2 to A1, I-2. Similarly, the central portion I-2 of the first-level notional region I-1 is also shown as being sub divided into 9 third-level notional regions A-3 to I-3. Again each of the other second-level notional regions A-2 to H-2 may also be sub divided into 9 corresponding third-level notional regions.

The levels of each of the notional regions are used to control zoom in and zoom out functions according to embodiments of the present invention. For example, embodiments can be arranged in which a video sequence is generated to reflect zooming between a view of the whole of the first-level image I and second-level view of that image I, which has reference numeral I-1. It will be appreciated such a video sequence, or, more accurately, such a pair of video sequences, would allow zoom in and zoom out function to be realised to allow the user to view the whole of the first-level image I or a portion I-1 of that image I. It can be appreciated that such a pair 2202 and 2204 of the video sequences are illustrated. The first video sequence 2202 of the pair is shown as comprises four frames, that is, a start frame I an end frame I-1, and a pair 2206 and 2208 of intermediate frames. The data for the start frame I is derived from the whole of the initial or original document or image I. The data for the end frame I-1 is derived from the central portion of the initial document I. The data for the intermediate frames 2206 and 2208 is derived from respective transition regions 2210 and 2212 of the original document I respectively. It will be appreciated that the video sequence has been illustrated as comprising four frames for the purposes of illustration only. In practice, the video sequence 2202 might contain many more intermediate frames according to a desired level of smoothness of the zooming between start image I and the end image I-1. In a similar manner zooming between document view I-1 and a further document view I-2 is also shown as comprises a pair of transitional images 2214 and 2216 these transitional image 2214 and 2216 are derived from respective transitional regions (not shown for the purpose of clarity) in a similar manner that the previously mentioned transition images 2206 and 2208 were derived from corresponding transition regions 2210 and 2212. Similarly a still further video sequence 2218 illustrating zooming between document views I-2 and I-3 comprising respective transition images 2220 and 2222 is also illustrated as discussed previously, the number of transition image derived from respective transition regions, can be set according to a desired smoothness of zooming. Therefore various video sequences can be generated at illustrate zooming between respective document views I, I-1, I-2 and I-3, for example, of the original document or image I.

It will be appreciated that zooming image sequences between the various notional levels of document view can be generated for each of the notional regions.

Still further, the above described 1-D and 2-D scrolling can also be used to generate image sequences for moving between the various notional regions.

Although the above embodiments have been described with reference to production of graphical elements representing arrows for controlling the zoom, embodiments are not limited to such an arrangement. Embodiments can be realised in which the scrolling or zooming functions are controlled via the IR remote control without the need to select the sub-picture menu options presented in the form of arrows. In such embodiments, the scrolling function may be performed in response to actuation of selected keys, such as, for example, up down and left right arrow keys that are provided on many IR remote controls.

It will be appreciated that the complexity of the links between the visual assets increases when stills or frames to support two-dimensional scrolling are authored. Rather than having, one average, a pair of links per visual assets, each visual asset will have, on average, at least two pairs of links to respective surrounding assets, assuming scrolling is limited to scrolling in two directions. However, it scrolling is supported in other directions, such as in NE-SW and/or NW-SE directions, the number of links to surrounding or successive assets will again be increased.

Furthermore, although the above embodiments have illustrated using scrolling in mutually orthogonal directions NS and EW directions, they are not limited to such an arrangement. Embodiments can be realised in which scrolling in other mutually orthogonal directions can be implemented in addition to, or as an alternative to, the NS and EW scrolling.

The DVD authoring method and apparatus described above have a number of advantages. Creating components that represent parameterised sections of audio visual content allow many individual AV assets to be implicitly defined and then automatically created. Repetitive manual tasks are avoided, which were previously time consuming, expensive and error-prone. The authoring method and apparatus significantly enhance the range of features available in existing categories of audiovisual product such as movie presentations. They also allow new categories of audiovisual product to be produced. These new categories include both entertainment product such as quiz-based games and puzzle-based games, as well as information products such as catalogues, directories, reference guides, dictionaries and encyclopaedias. In each case, the authoring method and apparatus described herein allow full use of the video and audio capabilities of DVD specifications such as DVD-video. A user may achieve playback using a standard DVD player with ordinary controls such as a remote control device. A DVD-video product having highly complex navigational content is readily created in a manner which is simple, efficient, cost effective and reliable.

Although a few preferred embodiments have been shown and described, it will be appreciated by those skilled in the art that various changes and modifications might be made without departing from the scope of the invention, as defined in the appended claims.

The audiovisual product comprises at least any one of data representing audiovisual content, DVD video disc image data, other data compliant with the DVD specification or a medium storing such data.

Although the above embodiments have been described with reference to the product being playable by a “standard DVD player”, it will be appreciated that other players can equally well be accommodated such as, for example, software players, set-top boxes or other means of processing or otherwise rendering audiovisual content using hardware or software or a combination of hardware and software.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings) and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. An authoring method for use in creating an audiovisual product, comprising the steps of:
defining a plurality of components, the components implicitly representing functional sections of audiovisual content with respect to one or more raw content objects, and a plurality of transitions that represent movements between the plurality of components;
expanding the plurality of components and the plurality of transitions to provide a set of explicitly realised AV assets (set of scrolling image data) and an expanded intermediate data structure of nodes and links (links to the set of scrolling image data and to images of each scrolling set—that is the video sequences within each set showing the scrolling), where each node is associated with an AV asset of the set and the links represent movement from one node to another; and
creating an audiovisual product in a predetermined output format, using the AV assets and the expanded intermediate data structure of the nodes and the links, wherein the audiovisual product comprises data to produce scrolling image data.

2. The method of claim 1, wherein the defining step comprises defining at least one information component that comprises a reference to a raw content object.

3. The method of claim 2, wherein the reference denotes a file path to a location where the raw content object is stored.

4. The method of claim 1, wherein the defining step comprises defining at least one choice component comprising a reference to at least one raw content object, and at least one authoring parameter.

5. The method of claim 4, wherein the at least one authoring parameter is adapted to control a selection or modification of the at least one raw content object.

6. The method of claim 4, wherein the at least one authoring parameter comprises a runtime variable available during playback of the audiovisual product.

7. The method of claim 4, wherein the at least one authoring parameter comprises an authoring-only parameter that will not be available during playback of the audiovisual product.

8. The method of claim 4, wherein the choice component comprises a reference to a presentation template and a reference to at least one substitutable raw content object to be placed in the template according to the at least one authoring parameter.

9. The method of claim 1, wherein the defining step comprises defining at least one meta-component representing a set of components and transitions.

10. The method of claim 9, wherein the at least one meta-component is a procedurally defined representation of the set of components and transitions.

11. The method of claim 1, wherein each transition represents a permissible movement from one component to another component.

12. The method of claim 1, wherein each transition is associated with a triggering event.

13. The method of claim 12, wherein the triggering event is an event occurring during playback of the audiovisual product.

14. The method of claim 13, wherein the triggering event is receiving a user command, or expiry of a timer.

15. The method of claim 1, further comprising the step of checking expected conformance of the audiovisual product with the predetermined output format, using the plurality of components and the plurality of transitions.

16. The method of claim 15, wherein the predetermined output format is a hierarchical data structure having limitations on a number of objects that may exist in the data structure at each level of the hierarchy, and the checking step comprises predicting an expected number of objects at a level and comparing the expected number with the limitations of the hierarchical data structure.

17. The method of claim 15, wherein the checking step comprises predicting an expected total size of the audiovisual product, and comparing the expected total size against a storage capacity of a predetermined storage medium.

18. The method of claim 1, wherein the expanding step comprises, for each component, building one or more of the set of explicitly realised AV assets by reading and manipulating the one or more raw content objects.

19. The method of claim 18, wherein:
the defining step comprises defining at least one choice component comprising a reference to a plurality of raw content objects and at least one authoring parameter; and
the building step comprises:
selecting one or more raw content objects from amongst the plurality of raw content objects using the at least one authoring parameter; and
combining the selected raw content objects to form one of the AV assets.

20. The method of claim 19, comprising repeating the selecting and combining steps to automatically build a plurality of the explicitly realised AV assets from the one of the components.

21. The method of claim 1, wherein the expanding step comprises:
creating from each one of the plurality of components one or more explicitly realised AV assets to provide the set of AV assets;
creating the expanded intermediate data structure wherein each node represents one AV asset of the set; and
creating a set of links between the nodes.

22. The method of claim 1, wherein each transition is associated between first and second components, and creating the set of links comprises evaluating each transition to create one or more links, each of the links being between a node created from the first component and a node created from the second component.

23. The method of claim 1, wherein the expanding step comprises evaluating at least one of the transitions to create exit logic associated with at least one first node, evaluating one of the components to create entry logic associated with at least one second node, and providing a link between the first and second nodes according to the entry logic and the exit logic.

24. The method of claim 23, wherein at least one of the transitions is associated with a triggering event, and the expanding step comprises evaluating the triggering event to determine the exit logic associated with the at least first one node.

25. The method of claim 1, further comprising the step of checking expected conformance of the audiovisual product with the predetermined output format, using the AV assets and the expanded intermediate data structure of nodes and links.

26. The method of claim 25, wherein the predetermined output format is a hierarchical data structure having limitations on a number of objects that may exist in the data structure at each level of the hierarchy, and the checking step comprises predicting an expected number of objects at a level and comparing the expected number with the limitations of the hierarchical data structure.

27. The method of claim 26, wherein the checking step comprises predicting an expected total size of the audiovisual product, and comparing the expected total size against a storage capacity of a predetermined storage medium.

28. The method of any preceding claim, wherein the AV assets have a data format specified according to the predetermined output format.

29. The method of claim 1, wherein the AV assets each have a data format according to the predetermined output format, whilst the raw content objects are not limited to a data format of the predetermined output format.

30. The method of claim 1, wherein the predetermined output format is a DVD-video specification.

31. The method of claim 1, wherein the AV assets each comprise a video object, zero or more audio objects, and zero or more sub-picture objects.

32. The method of claim 1, wherein the AV assets each comprise at least one video object, zero to eight audio objects, and zero to thirty-two sub-picture objects, according to the DVD-video specification.

33. The method of claim 1, wherein the creating step comprises creating objects in a hierarchical data structure defined by the predetermined output format with objects at levels of the data structure, according to the intermediate data structure of nodes and links, and where the objects in the hierarchical data structure include objects derived from the explicitly realised AV assets.

34. The method of claim 1, wherein the predetermined output format is a DVD-video specification and the creating step comprises creating DVD-video structure locations from the nodes of the expanded intermediate data structure, placing the explicitly realised AV assets at the created structure locations, and substituting the links of the expanded intermediate data structure with explicit references to the DVD-video structure locations.

35. An authoring method for use in creating a DVD-video product, comprising the steps of:
creating a plurality of components representing parameterized sections of audiovisual content, and a plurality of transitions representing movements between components;
expanding the plurality of components and the plurality of transitions to provide a set of AV assets and an expanded data structure of nodes and links, where each node is associated with an AV asset of the set and the links represent movement from one node to another; and
creating a DVD-video format data structure from the AV assets, using the nodes and links, wherein the DVD-video format data structure comprises data arranged to produce scrolling image data.

36. The method of claim 35, further comprising creating at least one information component comprising a reference to an item of AV content.

37. The method of claim 35, further comprising creating at least one choice component comprising a reference to at least one item of AV content, and at least one parameter for modifying the item of AV content.

38. The method of claim 37, wherein the choice component comprises a reference to a presentation template and a reference to at least one item of substitutable content to be placed in the template according to the at least one parameter.

39. The method of claim 37, wherein the choice component comprises at least one runtime variable available during playback of an audiovisual product in a DVD player, and at least one authoring parameter not available during playback.

40. The method of claim 35, further comprising creating at least one meta-component representing a set of components and transitions.

41. The method of claim 35, wherein each transition represents a permissible movement from one component to another component, each transition being associated with a triggering event.

42. The method of claim 41, wherein a triggering event includes receiving a user command, or expiry of a timer.

43. The method of claim 35, wherein the expanding step comprises:
creating from each one of the plurality of components one or more AV assets to provide the set of AV assets;
creating the expanded data structure wherein each node represents one AV asset of the set; and
creating a set of links between the nodes.

44. The method of claim 37, wherein the expanding step comprises evaluating each choice component to create a plurality of AV assets according to each value of the at least one parameter.

45. The method of claim 44, wherein evaluating each choice component comprises creating entry logic associated with at least one node and/or evaluating at least one transition to create exit logic associated with at least one node, and providing a link between a pair of nodes according to the entry logic and the exit logic.

46. The method of claim 35, further comprising the step of checking expected conformance with the DVD-video format using the created components and transitions.

47. The method of claim 35, further comprising the step of checking expected conformance with the DVD-video format using the set of AV assets and the expanded data structure of nodes and links.

48. An authoring method for use in creating an audiovisual product according to a DVD-video specification, comprising the steps of:
generating a set of AV assets each comprising a video object, zero or more audio objects and zero or more sub-picture objects, and an expanded data structure of nodes and links, where each node is associated with one AV asset of the set and the links represent navigational movement from one node to another; and
creating a DVD-video format data structure from the set of AV assets, using the nodes and links;
the method further characterized by the steps of:
creating a plurality of components and a plurality of transitions, where a component implicitly defines a plurality of AV assets by referring to a presentation template and to items of raw content substitutable in the presentation template, and the plurality of transitions represent navigational movements between components; and
expanding the plurality of components and the plurality of transitions to generate the set of AV assets and the expanded data structure of nodes and links, wherein the set of AV assets and the expanded data structure comprises data for producing, or at least emulating, scrolling image data.

49. A method as claimed in claim 48, further comprising the step of:
producing, from data representing a static visual asset, a set of visual assets in which each visual asset of the set comprises data unique to that asset and data common to that asset and at least one other visual asset of the set; each visual asset of the set having respective defined dimensions.

50. A method as claimed in claim 49, in which the step of producing the set of visual assets comprises the step of:
progressively traversing the static visual assets to copy data, from the static visual asset, to form respective visual assets of the set.

51. A method as claimed in claim 50 in which the step of traversing comprises the step of:
defining a predeterminable step size, less than at least one of the respective defined dimensions, and traversing the static visual asset according to that predeterminable step size.

52. A method as claimed of claim 49, further comprising the steps of:
creating, for each visual asset in the set, associated asset display control data comprising data representing at least one selectable graphical element and at least one link, associated with the selectable graphical element, to another visual asset of the set of visual assets.

53. A data processing method as claimed in claim 52, in which the step of creating comprises the step of:
creating, for selected or all visual assets of the set of visual assets, associated asset display control data comprising data representing at least a pair of selectable graphical elements and data representing at least a pair of links, associated with respective ones of the pair of selectable graphical elements, to a preceding visual asset and a succeeding visual asset of the set of visual assets.

54. A method as claimed in claim 49 in which at least one of the dimensions of the static visual asset exceeds at least one of the defined dimensions of at least one of the visual assets of the set of visual assets.

55. A method as claimed in claim 54, in which the dimensions of the static visual asset exceed two defined dimensions of at least one of the visual assets of the set of visual assets.

56. A method as claimed in claim 49 in which the step of producing the set of visual assets comprises the step of:
progressively traversing, in at least two different directions, the static visual asset to copydata, from the static visual asset, to form respective visual assets of the set.

57. A data processing method as claimed in any claim 56 in which the step of producing the set of visual assets comprises the step of:
progressively traversing, in at least two orthogonal directions, the static visual asset to copy data, from the static visual asset, to form respective visual assets of the set.

58. A data processing system for authoring optical medium data comprising:
means for producing, from data representing a static visual asset, a set of visual assets in which each visual asset of the set comprises data unique to that asset and data common to that asset and at least one other visual asset of the set; each visual asset of the set having respective defined dimensions.

59. A data processing system as claimed in claim 58 in which the means for producing the set of visual assets comprises means for progressively traversing the static visual asset to copy data, from the static visual asset, to form respective visual assets of the set.

60. A data processing system as claimed in claim 59 in which the means for traversing comprises means for defining a predeterminable step size, less than at least one of the respective defined dimensions, and traversing the static visual asset according to that predeterminable step size.

61. A data processing system as claimed in claim 58, further comprising
means for creating, for each visual asset in the set, associated asset display control data comprising data representing at least one selectable graphical element and at least one link, associated with the selectable graphical element, to another visual asset of the set of visual assets.

62. A data processing system as claimed in claim 61 in which the means for creating comprises:
means for creating, for selected or all visual assets of the set of visual assets, associated asset display control data comprising data representing at least a pair of selectable graphical elements and data representing at least a pair of links, associated with respective ones of the pair of selectable graphical elements, to a preceding visual asset and a succeeding visual asset of the set of visual assets.

63. A data processing system as claimed in claim 58 in which at least one of the dimensions of the static visual asset exceeds at least one of the defined dimensions of at least one of the visual assets of the set of visual assets.

64. A data processing system as claimed in claim 63 in which the dimensions of the static visual asset exceed two defined dimensions of the visual assets of the set of visual assets.

65. A data processing system as claimed of claim 58 in which the means for producing the set of visual assets comprises means for progressively traversing, in at least two different directions, the static visual asset to copy data, from the static visual asset, to form respective visual assets of the set.

66. A data processing system as claimed in claim 65 in which the means for producing the set of visual assets comprises means for progressively traversing, in at least two orthogonal directions, the static visual asset to copy data, from the static visual asset, to form respective visual assets of the set.

67. A computer program comprising code for implementing a method or system as claimed in claim 1.

68. A computer program product comprising a computer readable medium storing a computer program as claimed in claim 67.

69. A method of manufacturing a DVD product, the method comprising creating a data carrier comprising data representing at least the set of visual assets created using a method, system, computer program or computer program product as claimed in claim 1.

70. A method of manufacturing a DVD product, the method comprising:
reading a data carrier comprising data representing at least the set of visual assets created using a method or a system as claimed in claim 1; and
materially producing the DVD product using the data stored on the data carrier.

71. A DVD product comprising data representing a set of visual assets, the visual assets having been derived from a static visual asset such that at least a pair of successive visual assets of the set of visual assets comprise respective unique data and data common to the pair of successive visual assets thereby allowing a scrolling effect to be emulated when the pair of assets are successively displayed.

72-76. (canceled)

77. A medium storing computer executable instructions for performing the method of claim 1.

78. A medium storing an audiovisual product or associated data authored according to the method of claim 1.
